(19) United States
(12) Patent Application Publication
(10) Pub. No.: US 2022/0230631 A1
(43) Pub. Date: Jul. 21, 2022

(54) SYSTEM AND METHOD FOR CONVERSATION USING SPOKEN LANGUAGE UNDERSTANDING

(71) Applicant: PM Labs, Inc., Walnut, CA (US)

(72) Inventors: Arjun Kumeresh Maheswaran, BANGALORE (IN); Akhilesh Sudhakar, CHENNAI (IN); Manesh Narayan K., Ghaziabad (IN); Malar Kannan, Tirunelveli (IN)

(73) Assignee: PM Labs, Inc.

(21) Appl. No.: 17/151,566

(22) Filed: Jan. 18, 2021

(51) Int. Cl. G10L 15/18; G10L 15/02; G06F 40/40; H04L 12/58

(52) U.S. Cl. CPC G10L 15/18; H04L 51/02; G06F 40/40; G10L 15/02

(57) ABSTRACT

A system and method for conversion of speech to text using spoken language understanding are disclosed. The system includes a streaming automated speech recognition subsystem configured to receive an utterance associated with a user and convert the utterance to a text, a spoken language understanding manager subsystem configured to select one or more specialised automatic speech recognition from plurality of specialised automatic speech recognition subsystem, wherein each of selected specialised automatic speech recognition subsystem are configured to detect corresponding one or more specialised intents and one or more specialised entities, generate a special text and transmit the special text to a natural language understanding subsystem, the natural language understanding subsystem configured to receive the special text and the text as an input to a natural language understanding model and reconcile the input to form a structured processed text.

### FIELD OF INVENTION

Embodiments of a present disclosure relates to speech to text conversion, and more particularly to a system and method for conversion of speech to text using spoken language understanding.

### BACKGROUND

Technology today has taken a very fast pace and has changed our lives. Companies today can provide quick and personalized responses to customers. Voice-activated chatbots are the ones who can interact and communicate through voice.

Further, in order to recognize voice of a human the devices are equipped with Automated Speech Recognition (ASR). ASR is a technology that allows a user to speak rather than punching on a keypad and the ASR detects the speech and creates a text file of the words detected from the speech by deleting noise present in the speech.

Traditionally systems which are available for conversion of speech to text uses generic or streaming automated speech recognition. Further, such systems require huge dataset for training, which makes the training process very time consuming and complex. Moreover, such systems are unable to identify specific things in the speech due to limited ability of the generic automated speech recognition, which causes a lot of transcription errors and makes the system susceptible to failure. Moreover, these systems are only able to detect basic vocabulary in the speech provided by the user, which makes it very difficult for the system to detect any domain specific details given in the speech.

Hence, there is a need for a system and method for management of a talent network in order to address the aforementioned issues.

### BRIEF DESCRIPTION

In accordance with an embodiment of the disclosure, a system for conversion of speech to text using spoken language understanding is disclosed. The system includes a streaming automated speech recognition subsystem operable by the one or more processors. The streaming automated speech recognition subsystem is configured to receive an utterance associated with a user as an audio. The streaming automated speech recognition subsystem is also configured to convert the utterance associated with the user to a text.

The system includes a spoken language understanding manager subsystem communicatively coupled to the streaming automated speech recognition subsystem and operable by the one or more processors. The spoken language understanding manager subsystem is configured to select one or more specialised automatic speech recognition subsystem from a plurality of specialised automatic speech recognition subsystem corresponding to one or more priors provided to the spoken language understanding manager subsystem, wherein each of selected specialised automatic speech recognition subsystem is configured to detect corresponding one or more specialised intents and one or more specialised entities from the utterance associated with the user, generate a special text for each of the corresponding one or more specialised intents and the one or more specialised entities and transmit the special text to a natural language understanding subsystem. The system also includes the natural language understanding subsystem communicatively coupled to the spoken language understanding manager subsystem and operable by the one or more processors. The natural language understanding subsystem is configured to receive the special text from the specialised automatic speech recognition subsystem, and the text from the streaming automated speech recognition subsystem as an input to a natural language understanding model and reconcile the input received to form a structured processed text.

In accordance with another embodiment of the disclosure, a method for conversion of speech to text using spoken language understanding is disclosed. The method includes receiving an utterance associated with a user as an audio. The method also includes converting the utterance associated with the user to a text.

The method also includes selecting one or more specialised automatic speech recognition from plurality of specialised automatic speech recognition subsystem based on one or more priors provided, wherein each of selected specialised automatic speech recognition subsystem are configured to detect corresponding one or more specialised intents and one or more specialised entities from the utterance associated with the user, generate a special text for each of the corresponding one or more specialised intents and the one or more specialised entities and transmit the special text to a natural language understanding subsystem. The method also includes receiving the special text from each of the specialised automatic speech recognition subsystem, and text from the streaming automated speech recognition subsystem as an input to a natural language understanding model and reconcile the input received to form a structured processed text.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram representation of a system for conversion of speech to text using spoken language understanding in accordance with an embodiment of the present disclosure;

FIG. 2 is an exemplary embodiment representation of the system for conversion of speech to text using spoken language understanding of FIG. 1 in accordance with an embodiment of the present disclosure;

FIG. 3 is a block diagram of conversion computer system or a server of speech to text using spoken language understanding in accordance with an embodiment of the present disclosure; and

FIG. 4 is a flow diagram representing steps involved in a method for conversion of speech to text using spoken language understanding in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for conversion of speech to text using spoken language understanding is disclosed. The system includes one or more processors. The system includes a streaming automated speech recognition subsystem operable by the one or more processors. The streaming automated speech recognition subsystem is configured to receive an utterance associated with a user as an audio. The streaming automated speech recognition subsystem is also configured to convert the utterance associated with the user to a text.

The system includes a spoken language understanding manager subsystem communicatively coupled to the streaming automated speech recognition subsystem and operable by the one or more processors. The spoken language understanding manager subsystem is configured to select one or more specialised automatic speech recognition from plurality of specialised automatic speech recognition subsystem corresponding to one or more priors provided to the spoken language understanding manager subsystem, wherein each of selected specialised automatic speech recognition subsystem are configured to detect corresponding one or more specialised intents and one or more specialised entities from the utterance associated with the user, generate a special text for each of the corresponding one or more specialised intents and the one or more specialised entities and transmit the special text to a natural language understanding subsystem. The system also includes the natural language understanding subsystem communicatively coupled to the spoken language understanding manager subsystem and operable by the one or more processors. The natural language understanding subsystem is configured to receive the special text from each of the specialised automatic speech recognition subsystem, and text from the streaming automated speech recognition subsystem as an input to a natural language understanding model and reconcile the input received to form a structured processed text.

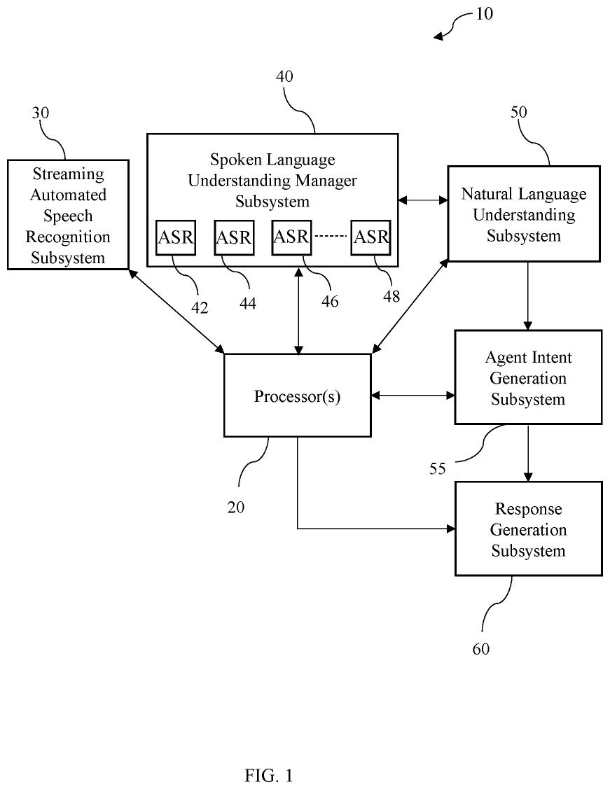

FIG. 1 is a block diagram representation of a system 10 for conversion of speech to text using spoken language understanding in accordance with an embodiment of the present disclosure. The system 10 includes one or more processors 20. In one embodiment, the system 10 may be hosted on a server. In such embodiment, the server may include a cloud server. The system 10 includes a streaming automated speech recognition subsystem 30 operable by the one or more processors 20. The streaming automated speech recognition subsystem 30 receives an utterance associated with a user as an audio. In such embodiment, the audio may include a speech audio from the user while interacting with a speech audio associated with a bot. As used herein, the term ‘bot’ refers to an autonomous program on the internet or another network that can interact with systems or users. In one specific embodiment, the system 10 may include a two way conversation system including a device capable of ingesting audio from a user and processing the audio to internally or externally via a remote server and interacting with plurality of users using plurality of bots.

Further, the streaming automated speech recognition subsystem 30 converts the utterance associated with the user to a text. In one embodiment, the streaming automated speech recognition may use a neural network technology for transcription of speech from a plurality of sources and plurality of languages. In one specific embodiment, the streaming automated speech recognition may include a generic automated speech recognition.

Further, the system 10 includes a spoken language understanding manager subsystem 40 communicatively coupled to the streaming automated speech recognition subsystem 30 and operable by the one or more processors 20. The spoken language understanding manager subsystem 40 selects one or more specialised automatic speech recognition from plurality of specialised automatic speech recognition subsystem 42-48 corresponding to one or more priors provided to the spoken language understanding manager subsystem 40. In an exemplary embodiment, the one or more priors may include one or more hints based on prior conversation history of the user or one or more intents and one or more entities identified from the utterance by the natural language understanding subsystem. In one embodiment, the one or more intents may be defined as a goal of the user while interacting with the bot. In such embodiment, the goal may be defined as an objective that the user has in mind while asking a question or a comment during interaction with the bot. In another embodiment, the one or more entities may be defined as an entity which is used to modify the one or more intents in the speech associated with the user to add a value to the one or more intents. In one embodiment, the one or more intents and the one or more entities may be collectively known as one or more priors.

In one embodiment, the one or more priors may be provided to the spoken language understanding manager subsystem 40 by the natural language understanding subsystem. In such embodiment, the natural language understanding subsystem receives the utterance and identifies at least one of an intent or an entity from the utterance. The at least one of the identified intent or the identified entity is transmitted as the one or more priors to the spoken language understanding manager subsystem 40 by the natural language understanding subsystem to select the one or more specialised automatic speech recognition subsystem.

In another embodiment, the one or more priors may be one or more hints based on prior conversation history of the user with the system. Such one or more hints may be provided to the spoken language understanding manager subsystem 40 to select the one or more specialised automatic speech recognition subsystems. In one embodiment, the one or more hints may include an expected response from a user based on an agent intent generated by an agent intent generation subsystem (discussed in detail below). In such embodiment, the plurality of specialised automatic speech recognition subsystem (ASR) may include a name ASR, a date ASR, a destination ASR, an alphanumeric ASR, a city ASR and the like.

In one exemplary embodiment, if the one or more intents and the one or more entities may include a date and destination then the date ASR and the destination ASR may be selected by the spoken language understanding manager subsystem 40. Each of the selected specialised automatic speech recognition subsystem detects corresponding one or more specialised intents and one or more specialised entities from the utterance associated with the user. Further, the each of the selected specialised automatic speech recognition subsystem generates a special text for each of the corresponding one or more specialised intents and the one or more specialised entities. In such embodiment, the special text may include a text output associated with the each of the selected specialised automatic speech recognition subsystem. The each of the selected specialised automatic speech recognition subsystem transmits the special text to a natural language understanding subsystem 50.

Further, the system 10 includes the natural language understanding subsystem 50 communicatively coupled to the spoken language understanding manager subsystem 40 and operable by the one or more processors 20. The natural language understanding subsystem 50 receives the special text and the text from each of the specialised automatic speech recognition subsystem, and the streaming automated speech recognition subsystem 30 respectively as an input to a natural language understanding model. The natural language understanding subsystem 50 also reconciles the input received to form a structured processed text. In such embodiment, the structured processed text may include one or more finalised intents and one or more finalised entities to be sent to generate an agent intent. In one embodiment, the natural language understanding model may decide an action to take with plurality of inputs received from the streaming ASR and each of the selected specialised ASR. In such embodiment, the action may include selecting a correct input from the one or more inputs received, generating the one or more finalised intents and the one or more finalised entities corresponding to the utterance associated with the user.

Further, in one embodiment, the system 10 may include an agent intent generation subsystem 55 communicatively coupled to the natural language understanding subsystem 50 and operable by the one or more processors 20. The agent intent generation subsystem 55 generates the agent intent based on the structured processed text received from the natural language understanding subsystem 50 in response to the utterance associated with the user. In one embodiment, As used herein, the term “agent intent” is a shorthand keyword-based representation for generating the text based agent response. For example, “Ask.Entity_Value.Name” is the agent intent, which is further used in the system to generate “Can you please give me your name?”. Further, in one embodiment, the system 10 may include a response generation subsystem 60 communicatively coupled to the agent intent generation subsystem 55 and operable by the one or more processors 20. The response generation subsystem 60 generates a complete sentence based on the agent intent as a response for the user. In one specific embodiment, the response generation subsystem also converts the complete sentence to an audio speech for the bot to give the audio response to the user.

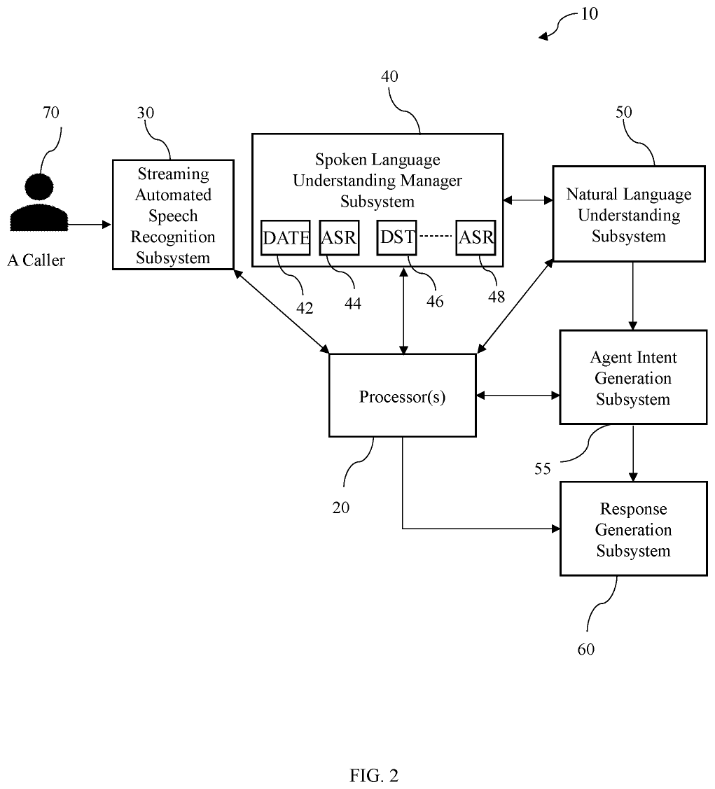

FIG. 2 is an exemplary embodiment representation of the system 10 for conversion of speech to text using spoken language understanding of FIG. 1 in accordance with an embodiment of the present disclosure. A caller 70 and a bot initiate a speech audio conversation by using a voice interface via a two way conversation system, wherein the two way conversation system acquires a speech data from the caller 70. Further, the system 10 receives an utterance associated with the caller 70 and converts the utterance associated with the caller 70 to a text using a streaming automated speech recognition, by a streaming automated speech recognition subsystem 30. The utterance associated with the caller 70 may include ‘I want to book a flight to honking on fifth of Number’. The system 10 then identifies the one or more intents as book and flight and the one or more entities as date and destination. Further, the streaming ASR detects the speech as ‘I want to book a flight to song on sixth of Number’, wherein the detected speech has one or more transcription errors.

Further, the system 10 selects the one or more specialised ASR from plurality of specialised automatic speech recognition subsystem 42-48 corresponding to the one or more intents and the one or more entities identified by the streaming automated speech recognition, by the spoken language understanding manager subsystem 40. The selected specialised ASR for the utterance may include a date ASR 42 and a destination ASR 46 represented by DST, wherein the date ASR 42 detects the date as ‘fifth of November’ and the destination ASR 46 detects the destination as ‘Hongkong’. Further, the system 10 generates a special text for each of the corresponding one or more specialised intents as ‘book and flight’ and the one or more specialised entities as ‘date—fifth of November and destination—Hongkong’. Further, the system 10 transmits the special text to a natural language understanding model. In one embodiment, the special text is the intent or the entity, which is communicated to the natural language understanding subsystem as a shorthand keyword-based representation for generating the text based agent response. Furthermore, the system 10 receives the special text and the text from the streaming ASRs and the specialised ASRs as the input to the natural language understanding model. Furthermore, the system 10 reconciles the input to form a structured processed text, generates the agent intent based on the structured processed text, by the agent intent generation subsystem 55 and feed the structured output to the caller 70, by response generation subsystem 60.

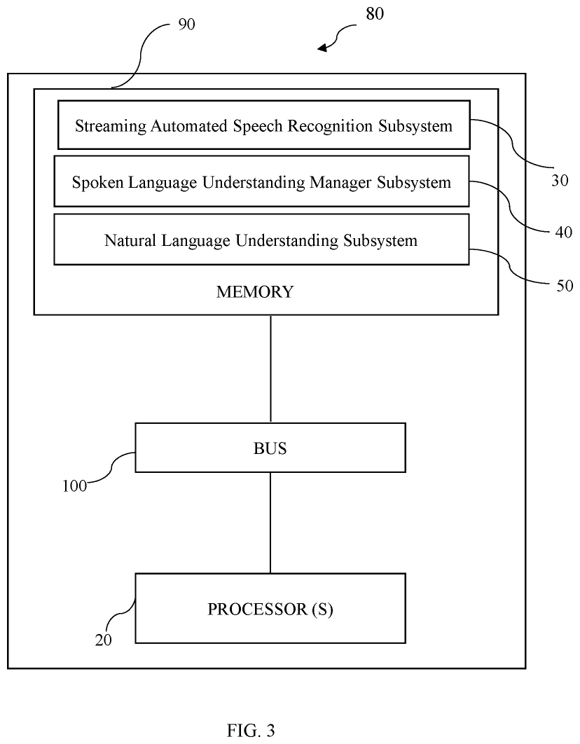

FIG. 3 is a block diagram of conversion computer system 80 or a server of speech to text using spoken language understanding in accordance with an embodiment of the present disclosure. The computer system 80 includes processor(s) 20, and memory 90 coupled to the processor(s) 20 via a bus 100. The memory 90 is stored locally on a seeker device.

The processor(s) 20, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 90 includes multiple units stored in the form of executable program which instructs the processor 20 to perform the configuration of the system illustrated in FIG. 2. The memory 90 has following units: a streaming automated speech recognition subsystem 30, a spoken language understanding manager subsystem 40 and a natural language understanding subsystem 50 of FIG. 1.

Computer memory 90 elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program subsystems, including functions, procedures, data structures, and application programs, for performing tasks, or defining abstract data types or low-level hardware contexts. The executable program stored on any of the above-mentioned storage media may be executable by the processor(s) 20.

The streaming automated speech recognition subsystem 30 instructs the processor(s) 20 to receive an utterance associated with a user as an audio, convert the utterance associated with the user to a text. The spoken language understanding manager subsystem 40 instructs the processor(s) 20 to select one or more specialised automatic speech recognition from plurality of specialised automatic speech recognition subsystem corresponding to one or more priors provided to the specialised automatic speech recognition subsystem, wherein each of selected specialised automatic speech recognition subsystem are configured to detect corresponding one or more specialised intents and one or more specialised entities from the utterance associated with the user, generate a special text for each of the corresponding one or more specialised intents and the one or more specialised entities and transmit the special text to a natural language understanding subsystem 60. The natural language understanding subsystem 60 instructs the processor(s) 20 to receive the special text and the text from each of the specialised automatic speech recognition subsystem, and the streaming automated speech recognition subsystem 30 respectively as an input to a natural language understanding model and reconcile the input received to form a structured processed text.

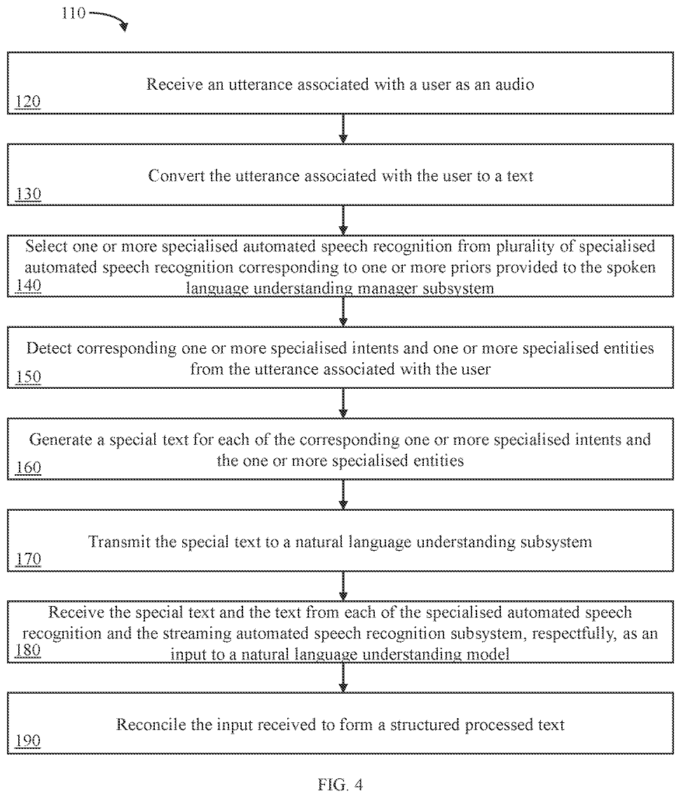

FIG. 4 is a flow diagram representing steps involved in a method 110 for conversion of speech to text using spoken language understanding in accordance with an embodiment of the present disclosure. The method 110 includes receiving, by a streaming automated speech recognition subsystem, an utterance associated with a user as an audio 120. In such embodiment, receiving the audio may include receiving a speech audio from the user while interacting with a speech audio associated with a bot. In one specific embodiment, the method 110 may include deploying plurality of bots for interacting with plurality of users and to acquire speech data from the user by using a two way conversation system.

Further, the method 110 includes converting, by the streaming automated speech recognition subsystem, the utterance associated with the user to a text 130. In one embodiment, the method 110 may include using a neural network technology for transcription of speech from a plurality of sources and plurality of languages.

Further, the method 110 includes selecting, by a spoken language understanding manager subsystem, one or more specialised automatic speech recognition from plurality of specialised automatic speech recognition subsystem corresponding to one or more priors provided to the spoken language understanding manager subsystem in step 140. In an exemplary embodiment, the one or more priors may include one or more hints based on prior conversation history of the user or one or more intents and one or more entities identified from the utterance by the natural language understanding subsystem. In one embodiment, the one or more intents may be defined as a goal of the user while interacting with the bot. In such embodiment, the goal may be defined as an objective that the user has in mind while asking a question or a comment during interaction with the bot. In another embodiment, the one or more entities may be defined as an entity which is used to modify the one or more intents in the speech associated with the user to add a value to the one or more intents. In one embodiment, the one or more intents and the one or more entities may be collectively known as one or more priors.

In one embodiment, the one or more priors may be provided to the spoken language understanding manager subsystem by the natural language understanding subsystem. In such embodiment, the natural language understanding subsystem receives the utterance and identifies at least one of an intent or an entity from the utterance. The at least one of the identified intent or the identified entity is transmitted as the one or more priors to the spoken language understanding manager subsystem by the natural language understanding subsystem to select the one or more specialised automatic speech recognition subsystem.

In another embodiment, the one or more priors may be one or more hints based on prior conversation history of the user with the system. Such one or more hints may be provided to the spoken language understanding manager subsystem to select the one or more specialised automatic speech recognition subsystems. In one embodiment, the one or more hints may include an expected response from a user based on an agent intent generated by an agent intent generation subsystem (discussed in detail below). In such embodiment, selecting form the plurality of specialised automatic speech recognition subsystem (ASR) may include selecting from a name ASR, a date ASR, a destination ASR, an alphanumeric ASR, a city ASR and the like.

Further, the method 110 includes detecting, by each of the selected specialised automatic speech recognition subsystem, corresponding one or more specialised intents and one or more specialised entities from the utterance associated with the user 150. The method 110 also includes generating, by the each of the selected specialised automatic speech recognition subsystem, a special text for each of the corresponding one or more specialised intents and the one or more specialised entities 160. In such embodiment, generating the special text may include generating a text output associated with the each of the selected specialised automatic speech recognition subsystem. The method 110 includes transmitting, by the each of the selected specialised automatic speech recognition subsystem, the special text to a natural language understanding subsystem 170.

Further, the method 110 includes receiving, by the natural language understanding subsystem, the special text and the text from each of the specialised automatic speech recognition subsystem, and the streaming automated speech recognition subsystem respectively as an input to a natural language understanding model 180. The method 110 also includes reconciling, by the natural language understanding subsystem, the input received to form a structured processed text 190. In such embodiment receiving the structured processed text may include receiving one or more finalised intents and one or more finalised entities to be sent to generate an agent intent. In one embodiment, the method 110 may include deciding, by the natural language understanding model, an action to take with plurality of inputs received from the streaming ASR and each of the selected specialised ASR. In such embodiment, deciding the action may include selecting a correct input from the one or more inputs received, generating the one or more finalised intents and the one or more finalised entities corresponding to the utterance associated with the user.

Further, in one embodiment, the method 110 may include generating, by an agent intent generation subsystem, the agent intent based on the structured processed text received from the natural language understanding subsystem in response to the utterance associated with the user.

Further, in one embodiment, the method 110 may include generating, a complete sentence based on the agent intent as a response for the user. In one specific embodiment, the method 110 may include converting the complete sentence to an audio speech for the bot to give the audio response to the user.

Various embodiments of the present disclosure provide a technical solution to the problem for conversion of speech to text using the spoken language understanding. The present system provides a precise conversion from speech to text using plurality of specialised automatic speech recognition subsystem. Further, the current system can detect industry specific things in the utterance received from the user by using the plurality of specialised automatic speech recognition subsystem, which makes the system more efficient and precise as a generic automated speech recognition is unable to detect the industry specific things such as a passenger name record number and the like.

While specific language has been used to describe the disclosure, any limitations arising on account of the same are not intended. As would be apparent to a person skilled in the art, various working modifications may be made to the method 230 (130) in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system for conversation using spoken language understanding comprising:
a streaming automated speech recognition subsystem operable by one or more processors, wherein the streaming automated speech recognition subsystem is configured to:
receive an utterance associated with a user as an audio;
convert the utterance associated with the user to a text;
a spoken language understanding manager subsystem communicatively coupled to the streaming automated speech recognition subsystem and operable by the one or more processors, wherein the spoken language understanding manager subsystem is configured to:
select one or more specialised automatic speech recognition subsystems from plurality of specialised automatic speech recognition subsystem subsystems corresponding to one or more priors provided to the spoken language understanding manager subsystem, wherein each of selected specialised automatic speech recognition subsystem is configured to:
detect corresponding one or more specialised intents and one or more specialised entities from the utterance associated with the user;
generate a special text for each of the corresponding one or more specialised intents and the one or more specialised entities; and
transmit the special text to a natural language understanding subsystem;
the natural language understanding subsystem communicatively coupled to the spoken language subsystem understanding manager and operable by the one or more processors, wherein the natural language understanding subsystem is configured to:
receive the special text from each of the specialised automatic speech recognition subsystem, and the text from the streaming automated speech recognition subsystem as an input to a natural language understanding model; and
reconcile the input received to form a structured processed text.

2. The system of claim 1, wherein the one or more priors comprises one or more hints based on prior conversation history of the user or one or more intents and one or more entities identified from the utterance by the natural language understanding subsystem.

3. The system of claim 1, wherein the one or more intents comprises a goal of the user while interacting with a bot.

4. The system of claim 1, wherein the one or more entities comprises an entity which is used to modify the one or more intents in the speech associated with the user to add a value to the one or more intents.

5. The system of claim 1, wherein the plurality of specialised automatic speech recognition subsystem comprises a name automated speech recognition, a date automated speech recognition, a destination automated speech recognition, an alphanumeric automated speech recognition and a city automated speech recognition.

6. The system of claim 1, wherein the special text comprises a text output associated with the each of the selected specialised automatic speech recognition subsystem.

7. The system of claim 1, wherein the structured processed text comprises one or more finalised intents and one or more finalised entities to be sent to generate an agent intent.

8. The system of claim 1, wherein the system comprises an agent intent generation subsystem communicatively coupled to the natural language understanding subsystem and operable by the one or more processors, wherein the agent intent subsystem is configured to generate the agent intent based on the structured processed text received from the natural language understanding subsystem in response to the utterance associated with the user.

9. The system of claim 1, wherein the system comprises a response generation subsystem communicatively coupled to the agent intent subsystem and operable by the one or more processors, wherein the response generation subsystem is configured to generate a complete sentence based on the agent intent as a response for the user.

10. A method for conversion of speech to text using spoken language understanding, the method comprising:
receiving, by a streaming automated speech recognition subsystem, an utterance associated with a user as an audio;
converting, by the streaming automated speech recognition subsystem, the utterance associated with the user to a text;
selecting, by a spoken language understanding manager subsystem, one or more specialised automatic speech recognition from plurality of specialised automatic speech recognition subsystems corresponding to the one or more priors provided to the spoken language understanding manager subsystem;
detecting, by each of selected specialised automatic speech recognition subsystem, corresponding one or more specialised intents and one or more specialised entities from the utterance associated with the user;
generating, by each of selected specialised automatic speech recognition subsystem, a special text for each of the corresponding one or more specialised intents and the one or more specialised entities;
transmitting, by each of selected specialised automatic speech recognition subsystem, the special text to a natural language understanding subsystem;
receiving, by the natural language understanding subsystem, the special text from each of the specialised automatic speech recognition subsystem and the text the streaming automated speech recognition subsystem as an input to a natural language understanding model; and
reconciling, by the natural language understanding subsystem, the input received to form a structured processed text.

11. The method of claim 10, wherein the one or more priors provided to the spoken language understanding manager subsystem comprises one or more hints based on prior conversation history of the user or one or more intents and one or more entities identified from the utterance by the natural language understanding subsystem.

12. The method of claim 10, wherein the one or more intents comprising a goal of the user while interacting with the bot.

13. The method of claim 10, wherein the one or more entities comprising an entity which is used to modify the one or more intents in the speech associated with the user to add a value to the one or more intents.

14. The method of claim 10, wherein the plurality of specialised automatic speech recognition subsystem comprising a name automated speech recognition, a date automated speech recognition, a destination automated speech recognition, an alphanumeric automated speech recognition and a city automated speech recognition.

15. The method of claim 10, wherein the special text comprising a text output associated with the each of the selected specialised automatic speech recognition subsystem.

16. The method of claim 10, wherein the structured processed text comprising one or more finalised intents and one or more finalised entities to be sent to generate an agent intent.

17. The method of claim 16, comprising generating, by an agent intent generation subsystem, the agent intent based on the structured processed text received from the natural language understanding subsystem in response to the utterance associated with the user.

18. The method of claim 17, comprising generating, by a response generation subsystem, a complete sentence based on the agent intent as a response for the user.
